(19) United States
(12) Patent Application Publication
(10) Pub. No.: US 2017/0195322 A1
(43) Pub. Date: Jul. 6, 2017

(54) ENTRY AND EXIT CONTROL METHOD AND APPARATUS, AND USER TERMINAL AND SERVER FOR THE SAME

(71) Applicant: ELECTRONICS AND TELECOMMUNICATIONS RESEARCH INSTITUTE, Daejeon (KR)

(72) Inventors: Young Seob CHO, Daejeon (KR); Seok Hyun KIM, Daejeon (KR); Soo Hyung KIM, Daejeon (KR); Seung Hyun KIM, Daejeon (KR); Jong Hyouk NOH, Daejeon (KR); Sang Rae CHO, Daejeon (KR); Jin Man CHO, Daejeon (KR); Seung Hun JIN, Daejeon (KR); Jung Yeon HWANG, Daejeon (KR)

(21) Appl. No.: 15/190,104

(22) Filed: Jun. 22, 2016

(30) Foreign Application Priority Data
Dec. 31, 2015 (KR) 10-2015-0190867

(51) Int. Cl. H04L 29/06

(52) U.S. Cl. CPC H04L 63/0861; H04L 63/06

(57) ABSTRACT

Disclosed are an entry and exit control method and apparatus, and a user terminal and a server. The entry and exit control method may be performed by the entry and exit control apparatus, and include broadcasting location information of the entry and exit control apparatus, receiving an authentication token from the user terminal providing a user authentication interface, verifying the received authentication token, and controlling an entry or an exit based on the verified authentication token, in which the authentication token may be issued by an entry and exit control server communicating with the entry and exit control apparatus at a request of the user terminal.

### CROSS-REFERENCE TO RELATED APPLICATION(S)

This application claims the priority benefit of Korean Patent Application No. 10-2015-0190867 filed on Dec. 31, 2015, in the Korean Intellectual Property Office, the disclosure of which is incorporated herein by reference for all purposes.

### BACKGROUND

1. Field

One or more example embodiments relate to an entry and exit control method and apparatus, and a user terminal and server for the entry and exit control method and apparatus.

2. Description of Related Art

In recent years, interest in entry and exit control has been growing due to a rapid increase in accidents related to a leak of confidential information by industrial spies and to burglaries and thefts occurring through an unauthorized access by an unauthorized person. An existing entry and exit control system may control an entry or exit of a user by issuing a card to a user for an entry into or exit from an area, recognizing a card of the user using a card recognizer provided in an entry and exit apparatus when the user attempts to make an entry into the area, verifying whether the card of the user corresponds to the issued card, and verifying whether the card is allowed for the entry into the area.

However, the entry and exit control system may allow an entry of an unauthorized person using an authorized card when the card is lost or stolen, or intentionally rented.

### SUMMARY

An aspect may provide an entry and exit control method and apparatus, and a user terminal and server for the entry and exit control method and apparatus in order to handle aforementioned issues.

The entry and exit control method and apparatus, and the user terminal and the server may be applied to prevent an entry (or an access) of an unauthorized person that may occur in case of a lost or stolen card, and an intentional rental of a card.

The entry and exit control method and apparatus, and the user terminal and the server may be applied to prevent an invasion of user privacy that may occur due to a bioinformation recognizer, and provide a convenient and safe offline entry and exit control function.

The aforementioned aspect may be achieved and include features to be described hereinafter.

According to an aspect, there is provided an entry and exit control method to be performed by an entry and exit control apparatus, the method including broadcasting location information of the entry and exit control apparatus, receiving an authentication token from a user terminal providing a user authentication interface, verifying the received authentication token, and controlling an entry and an exit based on the verified authentication token. The authentication token may be issued by an entry and exit control server communicating with the entry and exit control apparatus at a request of the user terminal.

The user authentication interface may be an interface configured to authenticate a user using bioinformation of the user.

The user authentication interface may be an interface configured to authenticate the user by additionally using a set password when the user is authenticated using the bioinformation of the user.

The verifying of the authentication token may include verifying the authentication token using a public key of the entry and exit control server. The public key may be registered in the entry and exit control server at a request of the user terminal.

The verifying of the authentication token may include requesting verification of the authentication token from the entry and exit control server communicating with the entry and exit control apparatus, and receiving a result of the requested verification from the entry and exit control server.

According to another aspect, there is provided an entry and exit control method to be performed by an entry and exit control server, the method including receiving, from a user terminal, a request for issuance of an authentication token, issuing the authentication token in response to the received request for the issuance, and transmitting the issued authentication token to the user terminal.

The method may further include receiving a request for verification of the authentication token from an entry and exit control apparatus communicating with the user terminal, verifying the authentication token in response to the received request for the verification, and transmitting a result of the verification to the entry and exit control apparatus.

According to still another aspect, there is provided an entry and exit control method to be performed by a user terminal, the method including receiving location information of an entry and exit control apparatus, providing a user authentication interface for user authentication, and transmitting, to the entry and exit control apparatus, an authentication token by a communication method selected based on the entry and exit control apparatus. The authentication token may be issued by an entry and exit control server communicating with the entry and exit control apparatus at a request of the user terminal.

The providing of the user authentication interface may include providing an interface to authenticate a user a number of times using bioinformation and a password of the user. When the user authentication is completed, the transmitting of the authentication token to the entry and exit control apparatus may include requesting the authentication token from the entry and exit control server, and receiving the authentication token from the entry and exit control server in response to the request.

The method may further include generating a public key pair corresponding to authentication information including the bioinformation of the user based on a user preference, and registering the generated public key pair in the entry and exit control server. The registered public key pair may be used by the entry and exit control server to verify the authentication token.

According to yet another aspect, there is provided an entry and exit control apparatus including a location information broadcaster configured to broadcast location information of the entry and exit control apparatus, an authentication token receiver configured to receive an authentication token from a user terminal providing a user authentication interface, an authentication token verifier configured to verify the received authentication token, and an entry and exit controller configured to control an entry and exit based on the verified authentication token. The authentication token may be issued by an entry and exit control server communicating with the entry and exit control apparatus at a request of the user terminal.

According to further another aspect, there is provided an entry and exit control server including an authentication token issuance request receiver configured to receive a request for issuance of an authentication token from a user terminal, an authentication token issuer configured to issue the authentication token in response to the received request for the issuance, and an authentication token transmitter configured to transmit the issued authentication token to the user terminal.

According to still another aspect, there is provided a user terminal including a location information receiver configured to receive location information of an entry and exit control apparatus, a user authentication interface provider configured to provide a user authentication interface for user authentication, and an authentication token transmitter configured to transmit an authentication token to the entry and exit control apparatus by a communication method selected based on the entry and exit control apparatus. The authentication token may be issued by an entry and exit control server communicating with the entry and exit control apparatus at a request of the user terminal.

According to still another aspect, there is provided an offline entry and exit control system using user terminal local authentication to provide a user with a safe and convenient entry and exit control service in an offline environment. The system may include an entry and exit control apparatus configured to open or close an entry and exit apparatus by transmitting a location of the entry and exit control apparatus and verifying an authentication token, a user terminal configured to perform local user authentication by receiving user authentication information and transfer, to the entry and exit control apparatus, the authentication token received from an entry and exit control server, and an authentication apparatus configured to issue the authentication token and transfer the issued authentication token to the user terminal and additionally verify the authentication token.

According to still another aspect, there is provided an entry and exit control apparatus including a location information transmitter configured to broadcast location information of the entry and exit control apparatus, an authentication token receiver configured to receive an authentication token from a user terminal, an authentication token verifier configured to directly verify the received authentication token, or request verification of the authentication token from an entry and exit control server when the entry and exit control server is connected online to the entry and exit control apparatus and is set to verify the authentication token in place of the entry and exit control apparatus, and an entry and exit opening and closing controller configured to open an entry and exit apparatus when an entry or exit of a user is allowed, and maintain the entry and exit apparatus to be in a closed state when the entry or exit of the user is disallowed.

According to still another aspect, there is provided a user terminal including a location information receiver configured to receive location information of an entry and exit control apparatus, a local authenticator configured to authenticate a user in the user terminal, an authentication token requester configured to request an authentication token from an entry and exit control server, and an authentication token transmitter configured to transmit, to the entry and exit control apparatus, the authentication token received from the entry and exit control server.

According to still another aspect, there is provided an entry and exit control server including an authentication token issuer configured to issue an authentication token after receiving a request for issuance of the authentication token from a user terminal, and to transfer the issued authentication token to the user terminal, and an authentication token verifier configured to verify the authentication token by receiving a request for verification of the authentication token from an entry and exit control apparatus and transfer a result of the verification to the entry and exit control apparatus.

According to still another aspect, there is provided an offline entry and exit control method using user terminal local authentication to provide a user with a safe and convenient entry and exit control service in an offline environment. The method may include registering user authentication information in a user terminal as an operation of registering a user in an offline entry and exit control system, requesting registration of a public key corresponding to the user authentication information from an entry and exit control server, registering a local authentication public key by the entry and exit control server, sending a result of registering the local authentication public key from the entry and exit control server to the user terminal, receiving location information of the user terminal when the user approaches a vicinity of an entry and exit control apparatus and determining a location of the user, performing local user authentication to authenticate the user by receiving the user authentication information registered in the user terminal, requesting issuance of an authentication token from the entry and exit control server, issuing the authentication token by the entry and exit control server to the user terminal, transferring the issued authentication token to the user terminal, verifying the authentication token transferred from the entry and exit control server to the user terminal, transferring the verified authentication token to the entry and exit control apparatus, verifying, by the entry and exit control apparatus, the authentication token transferred from the user terminal, and opening or closing an entry and exit apparatus based on a result of verifying the authentication token.

The registering of the user authentication information in the user terminal may include registering, as the authentication information, bioinformation of the user such as, for example, a fingerprint and an iris of the user, a password that is information remembered by the user, a device such as a smart card possessed by the user, or a combination of at least two sets of information described in the foregoing, based on an entry and exit control system policy, whether the user terminal supports the entry and exit control system, a user preference, and the like.

The requesting of the registration of the public key corresponding to the user authentication information, or local user authentication information, from the entry and exit control server may include generating public key information including a private-public key pair corresponding to the local user authentication information, configuring a plaintext authentication public key registration request message with a user identifier, a local authentication information identifier, and a local authentication information public key, and generating an authentication public key registration request message by signing the plaintext authentication public key registration request message with a local authentication information private key.

The performing of the local user authentication in the user terminal may include configuring the authentication information with the bioinformation such as the fingerprint and the iris, the password that is the information remembered by the user, or the device such as the smart card possessed by the user, or the combination of the at least two sets of information described in the foregoing, based on the entry and exit control system policy, whether the user terminal supports the entry and exit control system, and the user preference.

The issuing of the authentication token by the entry and exit control server may include configuring token information with, for example, an authentication result, user identification information, entry and exit control beacon information, and token expiration data information, and issuing the authentication token by signing the token information with a private key of the entry and exit control server.

The transferring of the authentication token to the entry and exit control apparatus from the user terminal may include transferring the authentication token using host card emulation (HCE), to use a Bluetooth low energy (BLE) or an existing smart card touch method based on a configuration of the entry and exit control system.

The verifying of the authentication token in the entry and exit control apparatus may further include requesting verification of the authentication token from the entry and exit control server to verify the authentication token when the entry and exit control server is set to verify the authentication token in place of the entry and exit control apparatus, verifying the authentication token by the entry and exit control server, and transferring, to the entry and exit control apparatus, a result of verifying the authentication token by the entry and exit control server.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of an entry and exit control method according to an example embodiment;

FIG. 2 is a flowchart illustrating an example of an entry and exit control method according to an example embodiment;

FIG. 3 is a flowchart illustrating another example of an entry and exit control method according to an example embodiment;

FIG. 4 is a flowchart illustrating still another example of an entry and exit control method according to an example embodiment;

FIG. 5 is a diagram illustrating an example of a process of registering authentication information according to an example embodiment;

FIG. 6 is a diagram illustrating an example of an interaction in an entry and exit control method according to an example embodiment; and

FIGS. 7A through 7C are diagrams illustrating an example of an entry and exit control method through user authentication according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

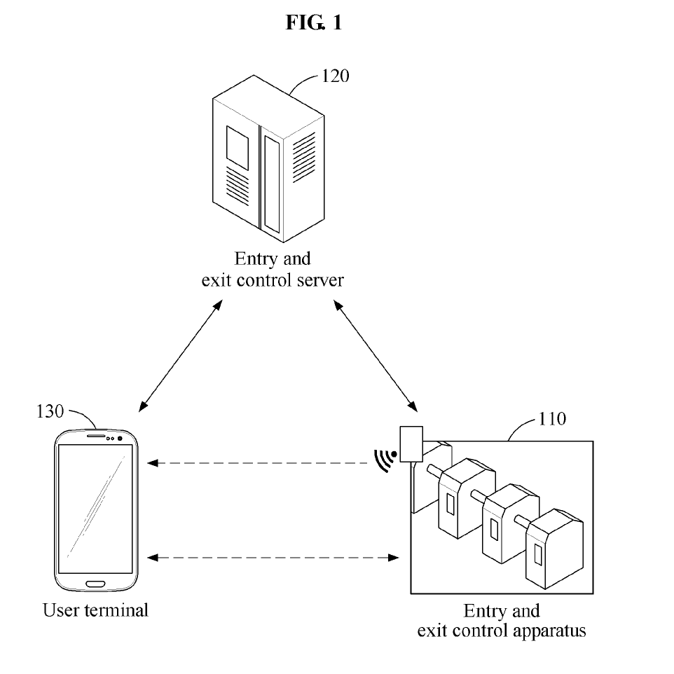

FIG. 1 is a diagram illustrating an example of an entry and exit control method according to an example embodiment.

Referring to FIG. 1, an overall entry and exit control system includes an entry and exit control apparatus 110, an entry and exit control server 120, and a user terminal 130.

The entry and exit control method may control an offline entry and/or exit through local authentication of the user terminal 130. For example, the entry and exit control apparatus 110 may open or close an entry and exit apparatus by transmitting a location of the entry and exit control apparatus 110 and verifying an authentication token transferred from the user terminal 130. The entry and exit control apparatus 110 may be, for example, a computing device that controls the entry and exit apparatus, or be an electronic device including at least one of a memory, a data transceiver, and a processor. The entry and exit apparatus may be installed indoors or outdoors, and installed in an entrance or exit, or an entrance and exit door, in a secure zone. The entry and exit control server 120 may issue the authentication token at a request of the user terminal 130, and allow the entry and exit control apparatus 110 to determine whether to allow or reject an entry or exit of a user. The user terminal 130 may allow the user to perform the local authentication for the entry and exit of the user and receive the authentication token to be transferred to the entry and exit control apparatus 110. The user terminal 130 may be a mobile communication device possessed by the user, such as, for example, a smartphone.

According to an example embodiment, the entry and exit control method may locally authenticate a user by a user terminal using bioinformation of a user, for example, a fingerprint, a voice, and an image, registered in the user terminal possessed by the user, a password that is remembered by the user, or a smart card possessed by the user. When an authentication token issued by an entry and exit control server is transferred to an entry and exit control apparatus via the user terminal based on a result of the local authentication, the entry and exit control apparatus may verify the authentication token to allow or reject an entry or exit of the user.

For example, the smart card may be used in a contact method in which the smart card is issued to the user and directly touches a card recognizer, or in a contactless method in which the smart card and the card recognizer communicate with each other wirelessly without the smart card directly touching the card recognizer. The bioinformation of the user, for example, a fingerprint and an iris of the user, may be registered in an entry and exit system, and input to a bioinformation recognizer attached to the entry and exit apparatus or scanned to be used for user authentication when the user attempts to make an entry or exit. Here, when the input or scanned bioinformation matches the pre-registered bioinformation, the entry or exit may be allowed. As necessary, communication between the smart card and the user terminal or communication between the user terminal and the entry and exit control apparatus may be performed by reading or writing a radio frequency (RF) tag or using near-field communication (NFC) technology.

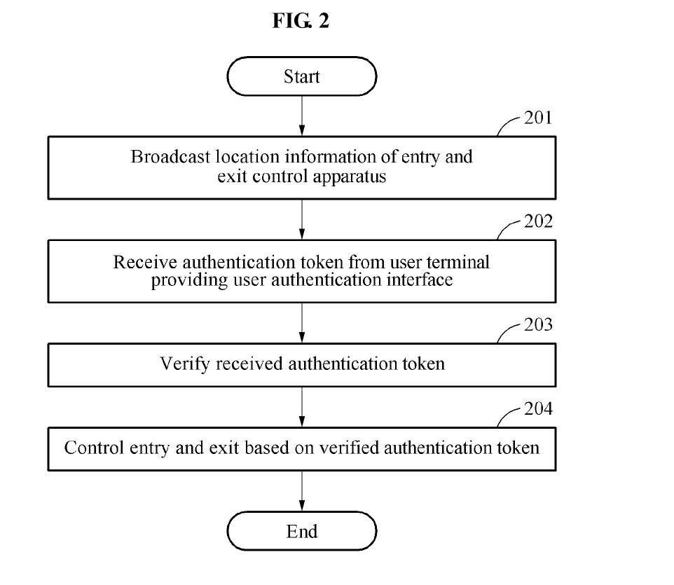

FIG. 2 is a flowchart illustrating an example of an entry and exit control method according to an example embodiment.

The entry and exit control method to be described hereinafter with reference to FIG. 2 may be performed by an entry and exit control apparatus.

According to an example embodiment, the entry and exit control apparatus may include a location information broadcaster, an authentication token receiver, an authentication token verifier, and an entry and exit controller. Here, the location information broadcaster, the authentication token receiver, the authentication token verifier, and the entry and exit controller may include at least one of a memory, a data transceiver, and a processor, but not limited thereto.

Referring to FIG. 2, in operation 201, the location information broadcaster broadcasts location information of the entry and exit control apparatus. The location information broadcaster may be a low-power beacon, but not limited thereto.

In operation 202, the authentication token receiver receives an authentication token from a user terminal providing a user authentication interface. The authentication token may be issued from an entry and exit control server communicating with the entry and exit control apparatus at a request of the user terminal. The user authentication interface may be an interface to authenticate a user using bioinformation of the user. When the user is authenticated using the bioinformation of the user, the user authentication interface may be an interface to authenticate the user further using a set password. The bioinformation of the user may be information stored by recognizing at least one of a fingerprint, an iris, an electrocardiogram (ECG), a blood pressure, a pulse, and a body temperature of the user, but not limited thereto.

In operation 203, the authentication token verifier verifies the received authentication token. The authentication token verifier may verify the authentication token using a public key of the entry and exit control server. Here, the public key may be a key registered in the entry and exit control server at a request of the user terminal. The authentication token verifier may request verification of the authentication token from the entry and exit control server communicating with the entry and exit control apparatus, and receive a result of the verification from the entry and exit control server. For example, the authentication token verifier may receive the result of the verification as “PASS” or “FAIL.” Alternatively, the authentication token verifier may receive the result of the verification as “access permitted” or “access rejected.” Also, as necessary, the authentication token verifier may receive the result of the verification as encoded data, for example, “28X2k,” corresponding to a permitted access and “Ok234” corresponding to a rejected access, for security. Here, the entry and exit control server may encode the result of the verification and transmit the encoded result to the entry and exit control apparatus.

In operation 204, the entry and exit controller controls an entry and exit based on the verified authentication token. For example, when the result of verifying the authentication token is “PASS,” the entry and exit controller may change, to an open state, a state of an entry and exit apparatus connected to the entry and exit control apparatus or a state of the entry and exit control apparatus. In addition, the entry and exit controller may change a state of a locking device or trigger the locking device to open an installed device that is currently closed, such as, for example, an entrance door.

According to an example embodiment, the entry and exit control apparatus may broadcast location information of the entry and exit control apparatus. In addition, the entry and exit control apparatus may receive an authentication token from a user terminal. Here, the entry and exit control apparatus may directly verify the received authentication token. As necessary, when an entry and exit control server is connected online to the entry and exit control apparatus and the entry and exit control server verifies the authentication token in place of the entry and exit control apparatus, the entry and exit control apparatus may selectively request verification of the authentication token from the entry and exit control server. In addition, the entry and exit control apparatus may physically allow or reject an access of a user.

According to an example embodiment, the entry and exit control apparatus may include a low-power beacon that may operate for several years with a battery without requiring an additional power supply. Here, the beacon may broadcast location information of the entry and exit control apparatus. In addition, the entry and exit control apparatus may receive the authentication token using wireless near-field communication (NFC) technology. For example, the entry and exit control apparatus may receive the authentication token using Bluetooth low energy (BLE) or NFC technology.

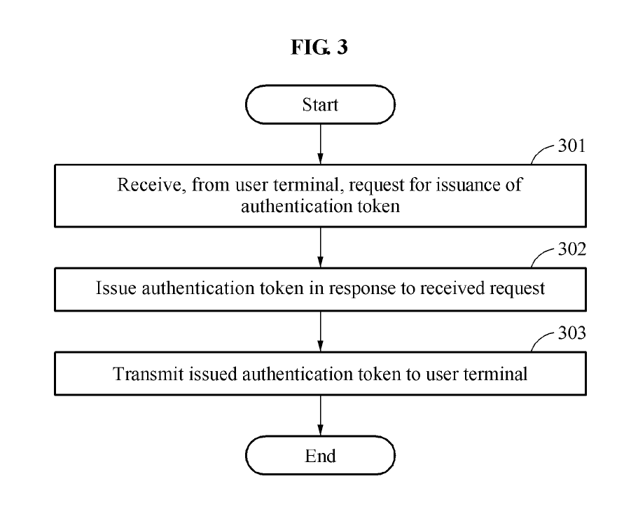

FIG. 3 is a flowchart illustrating another example of an entry and exit control method according to an example embodiment.

The entry and exit control method to be described hereinafter with reference to FIG. 3 may be performed by an entry and exit control server.

According to an example embodiment, the entry and exit control server may include an authentication token issuance request receiver, an authentication token issuer, and an authentication token transmitter. Here, the authentication token issuance request receiver, the authentication token issuer, and the authentication token transmitter may include at least one of a memory, a data transceiver, and a processor, but not limited thereto.

Referring to FIG. 3, in operation 301, the authentication token issuance request receiver receives, from a user terminal, a request for issuance of an authentication token. For example, the authentication token issuance request receiver may receive bioinformation of a user from the user terminal. As necessary, the authentication token issuance request receiver may receive, from the user terminal, at least one of a result of user authentication, user identification information, entry and exit control beacon information, and token expiration data information.

In operation 302, the authentication token issuer issues the authentication token in response to the received request for the issuance. For example, the authentication token issuer may generate information to recognize and store a user bioinformation identification number corresponding to the received bioinformation of the user or a pattern of a feature of the bioinformation. As necessary, the authentication token issuer may configure authentication token information with at least one of the result of user authentication, the user identification information, beacon information of an entry and exit control apparatus, and the token expiration date information, and sign the configured authentication token information with a private key of the entry and exit control server.

In operation 303, the authentication token transmitter transmits, to the user terminal, the issued authentication token. For example, the authentication token transmitter may transmit, to the user terminal, the information to recognize and store the user identification number generated corresponding to the received bioinformation of the user or the pattern of the feature of the bioinformation. As necessary, the authentication token transmitter may transmit, o the user terminal, at least one of the result of user authentication, the user identification information, the beacon information of the entry and exit control apparatus, and the token expiration date information as the authentication token information.

The entry and exit control server may receive, from the entry and exit control apparatus communicating with the user terminal, a request for verification of the authentication token, and verify the received authentication token in response to the received request for the verification. In addition, the entry and exit control server may transmit a result of the verification to the entry and exit control apparatus.

According to an example embodiment, the entry and exit control server may issue an authentication token by receiving a request for issuance of the authentication token from a user terminal, and transmit the issued authentication token to the user terminal. In addition, the entry and exit control server may verify the authentication token by receiving a request for verification of the authentication token from an entry and exit control apparatus, and transmit a result of the verification to the entry and exit control apparatus. The authentication token may be configured through various methods. For example, the entry and exit control server may configure authentication token information with a result of user authentication, user identification information, beacon information of the entry and exit control apparatus, and token expiration date information, and sign the authentication token information with a private key of the entry and exit control server. Here, the entry and exit control apparatus may verify the authentication token with a public key of the entry and exit control server.

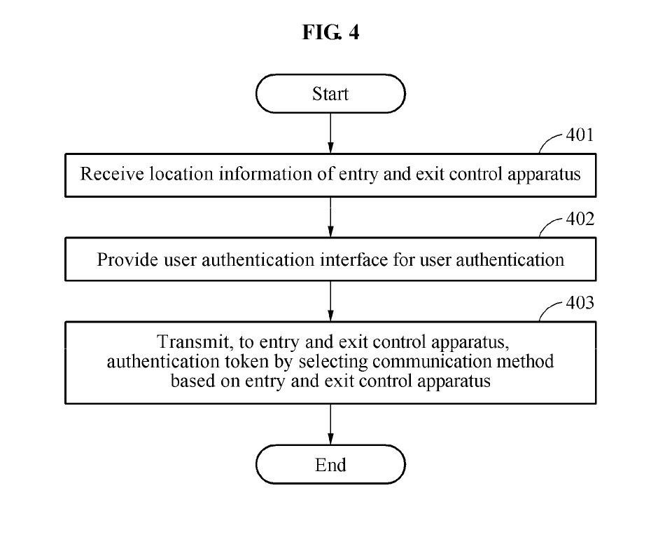

FIG. 4 is a flowchart illustrating still another example of an entry and exit control method according to an example embodiment.

The entry and exit control method to be described hereinafter with reference to FIG. 4 may be performed by a user terminal.

According to an example embodiment, the user terminal may include a location information receiver, a user authentication interface provider, and an authentication token transmitter. Here, the location information receiver, the user authentication interface provider, and the authentication token transmitter may include at least one of a memory, a data transceiver, and a processor, but not limited thereto.

Referring to FIG. 4, in operation 401, the location information receiver receives location information of an entry and exit control apparatus. For example, the location information receiver may receive, from a beacon of the entry and exit control apparatus, an internet protocol (IP) address as information associated with a location of the beacon or the entry and exit control apparatus, and a relative/absolute coordinate location.

In operation 402, the user authentication interface provider provides a user authentication interface for user authentication. For example, the user authentication interface provider may receive bioinformation of a user through a touch screen of the user terminal using an electrical and/or non-electrical signal and a pressure, and display and output a result of the user authentication on the touch screen.

The user authentication interface provider may provide an interface used to authenticate the user a number of times using the bioinformation and a password of the user.

In operation 403, the authentication token transmitter transmits, to the entry and exit control apparatus, an authentication token by a communication method selected based on the entry and exit control apparatus. Here, the authentication token may be issued from an entry and exit control server communicating with the entry and exit control apparatus at a request of the user terminal. As necessary, the authentication token transmitter may encode the authentication token and transmit the encoded authentication token to the entry and exit control apparatus.

When the user authentication is completed, the authentication token transmitter may request the authentication token from the entry and exit control server. In addition, the authentication token transmitter may receive the authentication token from the entry and exit control server in response to the request.

According to an example embodiment, the user terminal may generate a public key pair corresponding to authentication information including bioinformation of a user. In addition, the user terminal may register the generated public key pair in an entry and exit control server. Here, using the registered public key pair, the entry and exit control server may verify whether a legitimate user requests issuance of an authentication token.

According to an example embodiment, the user terminal may receive location information of an entry and exit control apparatus. In addition, the user terminal may authenticate a user in the user terminal. Here, in response to a successful local authentication, the user terminal may request an authentication token from an entry and exit control server. The user terminal may transmit, to the entry and exit control apparatus, the authentication token transferred from the entry and exit control server.

According to an example embodiment, the user terminal may authenticate a user by comparing authentication information input by the user at a time of user authentication to authentication information pre-registered by the user, for example, bioinformation such as a fingerprint and an iris of the user, a password of the user, and a smart card possessed by the user. Here, the user terminal may transmit an authentication token to an entry and exit control apparatus using BLE and NFC based on a configuration of the entry and exit control apparatus.

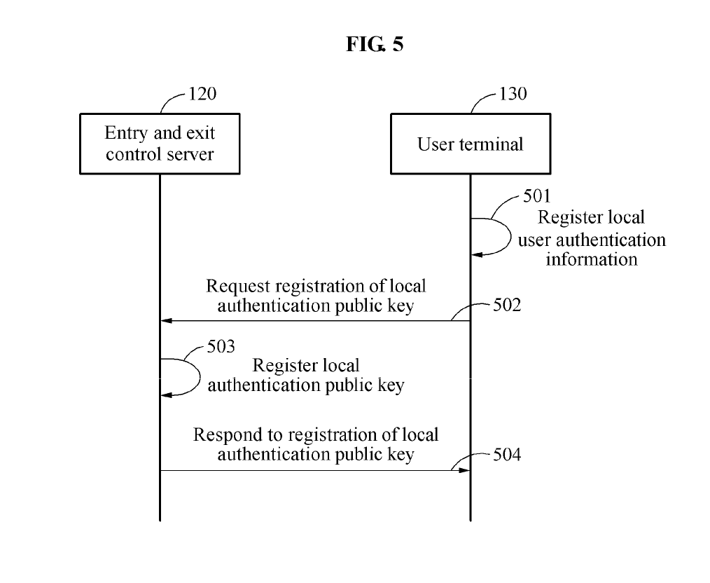

FIG. 5 is a diagram illustrating an example of a process of registering authentication information according to an example embodiment.

FIG. 5 illustrates an interaction, for offline entry and exit control, in which local user authentication information is registered in a user terminal, a public key pair corresponding to the local user authentication information is generated, and public key information is registered in an entry and exit control server.

Referring to FIG. 5, in stage 501, a user terminal 130 registers therein authentication information including bioinformation of a user as local user authentication information.

In stage 502 through 504, the user terminal 130 requests registration of the authentication information as a local authentication public key from an entry and exit control server 120. Here, the entry and exit control server 120 may register the local authentication public key and transmit, to the user terminal 130, a response message indicating that the local authentication public key is registered.

According to an example embodiment, a user terminal may configure authentication information with bioinformation such as a fingerprint and an iris of a user based on, for example, an entry and exit control system policy set by the user, whether the user terminal supports an entry and exit control system (for example, whether the user terminal is available for use), and a user preference. Also, the user terminal may configure the authentication information with a password input by the user. For example, a pattern touched or input by the user or an image or a picture may be configured as the password. Here, a personal identification number (PIN) input to the user terminal from the user may also be used as the password. In addition, text including a special character input by the user may also be used as the password.

According to an example embodiment, a user terminal may configure authentication information using a card, for example, a smart card, issued by an external institution such as a bank by authenticating a user and possessed by the authenticated user. Here, the smart card may be, for example, a one-time password (OTP) card and a credit card issued by a bank. As necessary, the smart card may be a card issued by an institution managing an entry and exit control apparatus, or a card selected from a plurality of cards possessed by the user and readable by the entry and exit control apparatus. The user terminal may register therein authentication information by configuring the authentication information with a combination of at least two sets of examples of authentication information described in the foregoing.

According to an example embodiment, a user terminal may generate a public key pair corresponding to local authentication information registered by a user as authentication information, and register public key information in an entry and exit control server. Here, the user terminal may allow the entry and exit control server to verify a result of local authentication using the public key information registered in the entry and exit control server.

The entry and exit control server may register the public key information at a request of the user terminal. The entry and exit control server may transmit a result of the registration of a local authentication public key to the user terminal. Here, the user terminal may receive, from the entry and exit control server, a message as a response to the result of the registration of the local authentication public key.

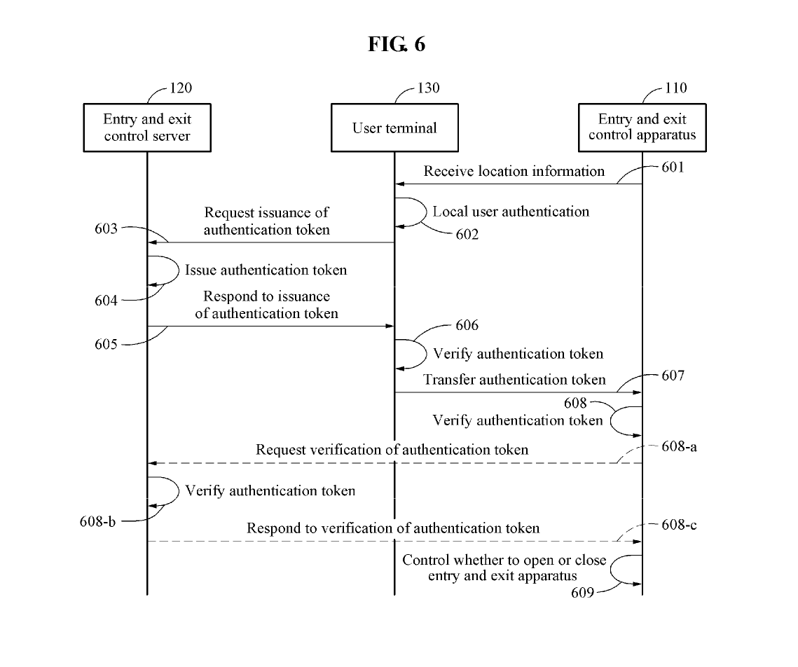

FIG. 6 is a diagram illustrating an example of an interaction in an entry and exit control method according to an example embodiment.

FIG. 6 illustrates a flow in which, when a user terminal approaches an entry and exit control apparatus, the user terminal, the entry and exit control apparatus, and an entry and exit control server interact with one another, and the entry and exit control apparatus controls an entry and an exit of a user.

Referring to FIG. 6, in stage 601, an entry and exit control apparatus 110 broadcasts location information of the entry and exit control apparatus 110 using a beacon located at an entrance and exit. The entry and exit control apparatus 110 may broadcast the location information of the entry and exit control apparatus 110 while continuously operating. Here, when a user terminal 130 approaches the entry and exit control apparatus 110, the user terminal 130 may receive the location information of the entry and exit control apparatus 110 to determine a location of a user.

In stage 602, for entry and exit control, the user terminal 130 requests local authentication from the user based on authentication information pre-registered in the user terminal 130. Here, in response to an unsuccessful local authentication, the user terminal 130 may display and output, to the user, a text indicating that the local authentication fails. The user terminal 130 may display and output, to the user, a text requesting a re-input of authentication information. In response to a successful local authentication, the user terminal 130 may perform a subsequent operation.

In stage 603, the user terminal 130 requests issuance of an authentication token from an entry and exit control server 120. Here, to allow the entry and exit control server 120 to perform verification on the authentication token with a public key, the user terminal 130 may sign request information about the request for the issuance of the authentication token with a private key corresponding to the public key pre-registered in association with the local authentication information of the user terminal 130. The request information to be signed with the private key may include a disposable challenge value that is temporarily shared with the entry and exit control server 120 and the user terminal 130 when issuing the authentication token, and include a disposable nonce generated in the user terminal 130 in order to allow the entry and exit control server 120 to perform the verification. That is, details to be signed may include a request for entry and exit control, a challenge, and a nonce.

In stages 604 and 605, the entry and exit control server 120 verifies the signing, for example, a signature, with an authentication information public key that signs the authentication token request information, and issues the authentication token after the signature is verified. Before verifying the signature of the authentication token request information, the entry and exit control server 120 may verify whether a challenge included in the request information is identical to a disposable challenge value that is temporarily shared between the entry and exit control server 120 and the user terminal 130. In addition, the entry and exit control server 120 may verify whether a nonce corresponds to a nonce of existing authentication token request information managed by the entry and exit control server 120. When the two verifications fail, the entry and exit control server 120 may not issue the authentication token, and transfer an error situation to the user terminal 130. Here, the entry and exit control server 120 may transfer the issued authentication token to the user terminal 130. For example, the entry and exit control server 120 may configure the authentication token with authentication token information including at least one of a result of user authentication, beacon information of the entry and exit control apparatus 110, and token expiration date information, and issue the authentication token by signing the configured authentication token with the private key of the entry and exit control server 120.

In stages 606 and 607, the user terminal 130 transmits, to the entry and exit control apparatus 110, the authentication token received from the entry and exit control server 120 using BLE or NFC technology based on a configuration of the entry and exit control apparatus 110. In addition, the user terminal 130 may transmit the authentication token to the entry and exit control apparatus 110 using HCE. Here, the user terminal 130 may output a user interface (UI) to request the user to touch on the user terminal 130.

In stages 608, 608-a, 608-b, and 608-c, the entry and exit control apparatus 110 determines whether to open or close an entry and exit apparatus by performing signature verification on the authentication token received from the user terminal 130 with the public key of the entry and exit control server 120 and by verifying the authentication token. As necessary, when an entry and exit control system is configured to allow the entry and exit control server 120 connected online to verify the authentication token, the entry and exit control apparatus 110 may request verification of the authentication token from the entry and exit control server 120. Here, the entry and exit control server 120 may verify the authentication token by receiving the request for the verification of the authentication token. In addition, the entry and exit control server 120 may transmit, to the entry and exit control apparatus 110, a result of the verification. The entry and exit control apparatus 110 may then determine whether to open or close the entry and exit apparatus.

In stage 609, when the entry of the user is allowed based on the result of the verification, the entry and exit control apparatus 110 opens the entry and exit apparatus. Conversely, when the entry of the user is rejected based on the result of the verification, the entry and exit control apparatus 110 controls the entry and exit apparatus to stay in a closed state, and transmits, to the user terminal 130, a message notifying the user of the rejection of the entry. As necessary, when the entry is rejected, the entry and exit control apparatus 110 may output a signal to allow entry and exit control apparatus 110 or the user terminal 130 to generate an alarm to notify the user of a state in which the entry is rejected.

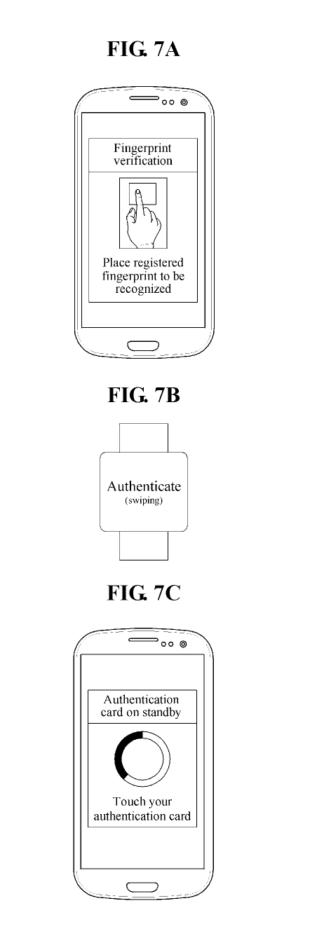

FIGS. 7A through 7C are diagrams illustrating an example of an entry and exit control method through user authentication according to an example embodiment.

FIG. 7A illustrates a method using a fingerprint as bioinformation of a user, FIG. 7B illustrates a method of swiping a screen of a smart watch additionally possessed by a user, and FIG. 7C illustrates a method of touching a smart card possessed by a user.

Referring to FIG. 7A, in the method using a fingerprint as bioinformation of a user, a user terminal may provide an interface to allow the user to input the fingerprint of the user by touching a touch screen of the user terminal or touching a home button. Here, the user terminal may perform local user authentication by storing, as authentication information, bioinformation of the user that is input to the user terminal.

Referring to FIG. 7B, in the method of swiping a screen of a smart watch additionally possessed by a user, a user terminal may provide an interface to allow the user to swipe a screen of a wearable device, for example, the smart watch, that communicates with the user terminal to perform additional authentication. For example, the user terminal may output a to message, for example, “make an input to a connected Swatch W-034 for authentication.” In addition, the user terminal may transmit, to the wearable device, a message to output a text “make an input for authentication” to the screen of the wearable device. The user terminal may be the wearable device, as necessary. Here, the user terminal may provide an interface to allow the user to input a swiping gesture for the additional authentication. For example, the user terminal may display a screen for the authentication. As necessary, when the user inputs a pattern, the user terminal may output a message “pattern input is completed.”

Referring to FIG. 7C, in the method of touching a smart card possessed by a user, when a smart card pre-registered in a user terminal by a user is touched, the user terminal may receive and obtain card identification information as authentication information of the user.

According to example embodiments, two-factor authentication may be provided by requiring a user to possess a portable terminal of the user for an entry and exit of the user and performing local authentication using bioinformation, a password, or a smart card of the user. Thus, a higher level of security than that provided by an existing entry and exit control system using a card or bioinformation may be provided, so that issues related to a loss, a theft, or an intentional rent of a card that may occur in the existing entry and exit control system may be properly handled.

In addition, a leak of bioinformation of a user that may occur due to a bioinformation recognizer of an entry and exit system may be prevented, and thus user privacy may be protected without a need for the user to input the bioinformation of the user to the bioinformation recognizer.

Further, an entry and exit control function convenient to a user may be provided because only local authentication is performed using a simple method in a portable terminal that is always carried by the user.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Therefore, the scope of the present disclosure is defined not by the detailed description, but by the claims and their equivalents, and all variations within the scope of the claims and their equivalents are to be construed as being included in the disclosure.

What is claimed is:

1. An entry and exit control method to be performed by an entry and exit control apparatus, the method comprising:
broadcasting location information of the entry and exit control apparatus;
receiving an authentication token from a user terminal providing a user authentication interface;
verifying the received authentication token; and
controlling an entry and exit based on the verified authentication token,
wherein the authentication token is issued by an entry and exit control server communicating with the entry and exit control apparatus at a request of the user terminal.

2. The method of claim 1, wherein the user authentication interface authenticates a user using bioinformation of the user.

3. The method of claim 1, wherein the user authentication interface authenticates a user using a wearable device or a smart card possessed by the user.

4. The method of claim 1, wherein the verifying of the authentication token comprises:
verifying the authentication token using a public key of the entry and exit control server,
wherein the public key is set in the entry and exit control apparatus or is transferred from the entry and exit control server to verify the authentication token when an entry and exit control system is constructed.

5. The method of claim 1, wherein the verifying of the authentication token comprises:
requesting verification of the authentication token from the entry and exit control server communicating with the entry and exit control apparatus; and
receiving a result of the requested verification from the entry and exit control server.

6. An entry and exit control method to be performed by an entry and exit control server, the method comprising:
receiving, from a user terminal, a request for issuance of an authentication token;
to issuing the authentication token in response to the received request for the issuance; and
transmitting the issued authentication token to the user terminal.

7. The method of claim 6, further comprising:
receiving a request for verification of the authentication token from an entry and exit control apparatus communicating with the user terminal;
verifying the authentication token in response to the received request for the verification; and
transmitting a result of the verifying to the entry and exit control apparatus.

8. An entry and exit control method to be performed by a user terminal, the method comprising:
receiving location information of an entry and exit control apparatus;
providing a user authentication interface for user authentication; and
transmitting, to the entry and exit control apparatus, an authentication token by a communication method selected based on the entry and exit control apparatus,
wherein the authentication token is issued by an entry and exit control server communicating with the entry and exit control apparatus at a request of the user terminal.

9. The method of claim 8, wherein the providing of the user authentication interface comprises:
providing an interface to authenticate a user a number of times using bioinformation and a password of the user or to authenticate the user using a wearable device or a smart card possessed by the user.

10. The method of claim 8, wherein the transmitting of the authentication token to the entry and exit control apparatus comprises:
requesting the authentication token from the entry and exit control server in response to completion of the user authentication; and
receiving the authentication token from the entry and exit control server in response to the request.

11. The method of claim 8, further comprising:
generating a public key pair corresponding to authentication information including bioinformation of a user based on a user preference; and
registering the generated public key pair in the entry and exit control server,
wherein the registered public key pair is used by the entry and exit control server to verify the authentication token.
